(19) United States
(12) Patent Application Publication
(10) Pub. No.: US 2007/0119231 A1
(43) Pub. Date: May 31, 2007

(54) Incidence probe

(76) Inventor: Joel Choisnet, Naviel (FR)

Correspondence Address: LOWE HAUPTMAN GILMAN & BERNER, LLP, 1700 DIAGNOSTIC ROAD, SUITE 300, ALEXANDRIA, VA, 22314, US

(21) Appl. No.: 10/579,722

(22) PCT Filed: Nov. 18, 2004
(86) PCT No.: PCT/EP04/53007

§ 371 Date: Jan. 18, 2007

(30) Foreign Application Priority Data
Nov. 18, 2003 (FR) 03/13492

(51) Int. Cl. G01N 29/02

(52) U.S. Cl. 73/23.24

(57) ABSTRACT

The invention pertains to an incidence probe intended to measure the incidence of an air stream flowing outside a skin. The invention finds particular utility in aeronautics for measuring the incidence of an aircraft. According to the invention, the incidence probe comprises a body situated outside the skin and means of measurement of a stress exerted by the air stream on the body.

### CROSS REFERENCES TO RELATED APPLICATIONS

The present Application is based on International Application No. PCT/EP2004/053007, filed on Nov. 18, 2004, which in turn corresponds to FR 03/13492 filed on Nov. 18, 2003, and priority is hereby claimed under 35 USC §119 based on these applications. Each of these applications are hereby incorporated by reference in their entirety into the present application.

### BACKGROUND OF THE INVENTION

The invention pertains to an incidence probe intended to measure the incidence of an air stream flowing outside a skin. The invention finds particular utility in aeronautics for measuring the incidence of an aircraft. It is of course understood that the invention is not limited to the aeronautical sector. It would be possible to implement the invention, for example, in a wind tunnel to determine the direction of an air stream or else in a weather station to determine the direction of the wind. Nevertheless the invention will be described in relation to an incidence probe mounted on the skin of an aircraft.

The incidence of an aircraft is defined as being the angle of the air speed vector with respect to a horizontal plane of the aircraft. Likewise, we define the sideslip of an aircraft as being the angle of the air speed vector with respect to a vertical plane, generally a symmetry plane, of the aircraft. The incidence and the sideslip are of a great significance for the piloting of the aircraft. Specifically they determine with the speed, the lift and the drag, that is to say the forces exerted by the air on the aircraft. Their knowledge is fundamental for the security of the flight and particularly in the takeoff and landing phases during which the speed of the aircraft is low and the incidence high, that is to say close to stalling. The sideslip must, for its part, remain well controlled. Aircraft are equipped with incidence and sideslip probes for the measurement of these parameters. In practice one and the same probe can be used either to measure the incidence or to measure the sideslip depending on its location on the skin of the aircraft. This type of probe measures locally the direction of the air with respect to the skin of the aircraft. We then speak of local incidence. Hereafter in the description, no distinction will be made as regards the purpose of the probe. It is of course understood that the invention applies both to incidence probes and to sideslip probes. We shall subsequently call this type of probe an incidence probe.

There exist two main families of incidence probes. The first family is formed by probes termed movable. They comprise a movable element that orients itself in the direction of the air stream. This movable element is generally a movable vane rotating around an axis perpendicular to the skin of the aircraft. The incidence measurement is carried out by measuring the angular position of the movable element around its rotation axis. These probes exhibit friction between the movable element and the skin of the aircraft. This friction disturbs the measurement all the more the lower the speed of the air stream. Specifically at low speed, the aerodynamic forces exerted on the movable element are low and have difficulty in overcoming friction. Moreover, it is necessary to ensure the leaktightness of the probe at the level of the junction between the movable vane and the skin of the aircraft.

The second family is formed by probes termed fixed. They comprise a fixed body protruding with respect to the skin of the aircraft. The fixed body is aerodynamically streamlined and comprises several pressure taps. The pressure measurements carried out by means of the pressure taps make it possible to calculate the incidence of the air stream with respect to the fixed body. These probes do not exhibit friction but are vulnerable at the level of the pressure taps which can clog up with water or during the passage of the aircraft through dust clouds, rendering pressure measurements and therefore determination of incidence impossible.

Certain movable probes can comprise pressure taps so as to improve the orientation of the movable element in the direction of the air stream. They then aggregate the drawbacks of the two families of probes previously described.

### SUMMARY OF THE INVENTION

The invention has the aim of alleviating the drawbacks of the two families of probes by proposing a new principle of fixed incidence probe, therefore frictionless, with no pressure tap.

For this purpose the subject of the invention is an incidence probe, intended to measure the incidence of an air stream flowing outside a skin, characterized in that it comprises a body situated outside the skin and means of measurement of a stress exerted by the air stream on the body.

### BRIEF DESCRIPTION OF THE DRAWING

The invention will be better understood and other advantages will appear on reading the detailed description of two embodiments given by way of examples, the description being illustrated by the attached drawing in which:

FIG. 1 represents a body forming a part sensitive to an air stream of an incidence probe;

FIGS. 2a and 2b represent a first embodiment of the invention in which means of measurement of a stress exerted by the air stream on the body comprise strain gauges;

FIGS. 3a and 3b represent a second embodiment of the invention in which the means of measurement of a stress exerted by the air stream on the body comprise electrodes forming capacitors;

FIG. 4 represents the incidence probe represented in FIG. 1 supplemented with wall pressure taps.

### DETAILED DESCRIPTION OF THE PREFERED EMBODIMENT

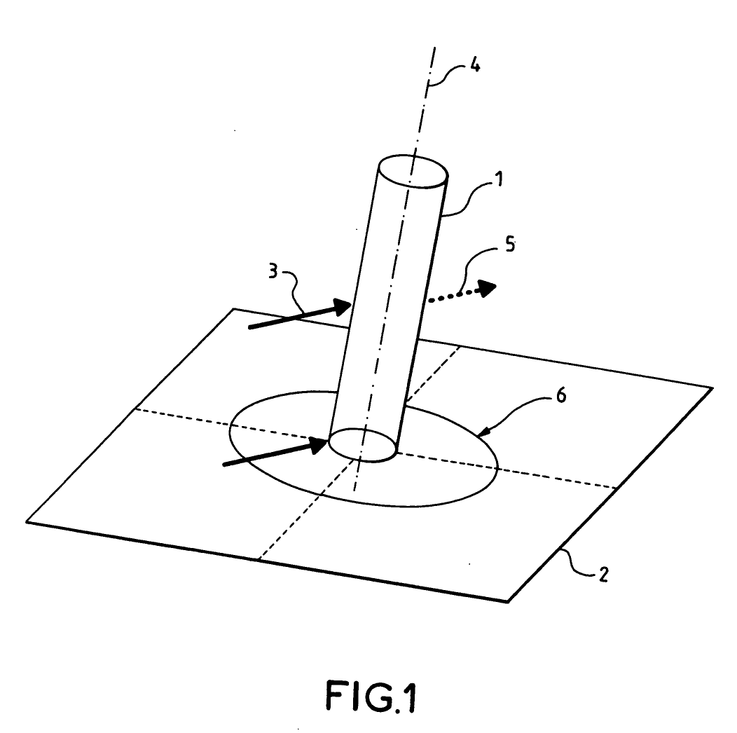

The incidence probe represented in FIG. 1 comprises a body 1 situated outside a skin 2, for example that of an aircraft. The body 1 forms the sensitive part of the incidence probe. The direction of an air stream, demarcated by the arrow 3, that we desire to determine by means of the incidence probe is parallel to the skin 2. In its simplest configuration, the body 1 is axisymmetric about an axis 4 substantially perpendicular to the surface of the skin 2. In FIG. 1, the body 1 is a cylinder of axis 4. To simplify the description, the cylinder will also bear the label 1. The cylinder 1 is subjected to aerodynamic forces created by the air stream. Because of the axisymmetry of the cylinder 1, the resultant of these aerodynamic forces is the drag 5 whose direction is identical to the direction 3 of the air stream. The incidence probe comprises means of measurement of a stress exerted by the air stream on the body 1, stated otherwise, means of measurement of the drag 5. By measuring the direction of the drag 5 the incidence of the air stream with respect to the probe is obtained directly on account of the identity of direction between that of the air stream and that of the drag 5.

The drag 5 is balanced by reaction forces of a plate 6 ensuring the fixing of the body 1 to the skin 2. Advantageously, the means of measurement of a stress comprise elastic means maintaining the body 1 secured to the skin 2, and means of measurement of relative position of the body 1 with respect to the skin 2.

A plate 6 forms the elastic means maintaining the body 1 secured to the skin 2. More precisely, by giving the plate 6 some elasticity, the modification of the relative position of the body 1 with respect to the skin 2 is representative of the drag 5 and therefore of the direction of the air stream. By measuring this modification it is therefore possible to determine the incidence of the air stream with respect to the probe.

It is of course possible to give the body 1 an entirely other form than that represented in FIG. 1. The body 1 can for example form the body of another probe mounted on an aircraft, such as for example a Pitot tube or a total temperature probe. On account of the absence of axisymmetry of this probe, the resultant of the aerodynamic forces exerted by the air stream on the body 1 can have a different direction to that of the air stream. The resultant of the aerodynamic forces is then the sum of the drag and of the lift. These two forces are exerted by the air stream. It is nevertheless possible to define a one-to-one relation between the resultant of the aerodynamic forces and the incidence of the air stream. This relation is for example defined in an empirical manner by wind tunnel trials. This relation takes account essentially of the speed and the incidence of the air stream. It is possible, as previously, to determine the incidence of the air stream with respect to the probe on the basis of a measurement of the stress exerted by the air stream on the body 1.

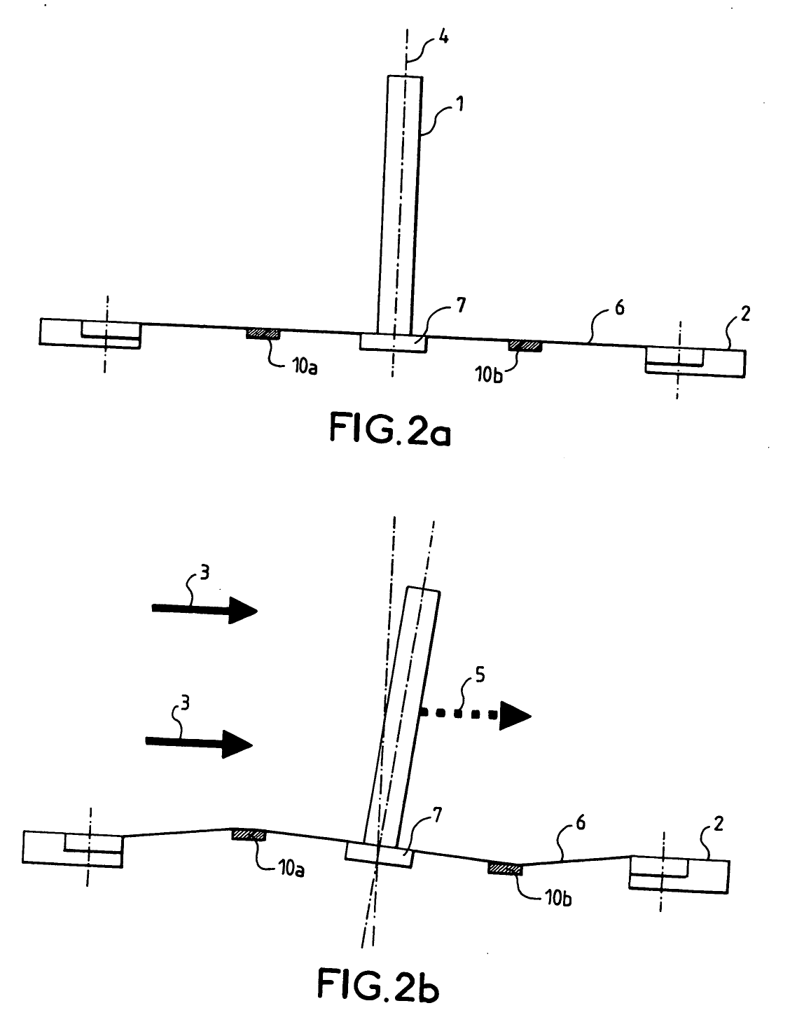

Advantageously, the incidence probe comprises a counterweight 7 fixed to the body 1 and disposed so that the centre of gravity of an assembly formed by the body 1 and the counterweight 7 is substantially situated at the level of the surface of the skin 2. The counterweight 7 is visible in FIG. 2a. The modification of the relative position of the body 1 with respect to the skin 2 is then essentially done by a rotation around the centre of gravity of the assembly. The position of the centre of gravity of the assembly at the level of the skin 2 makes it possible to limit the sensitivity of the measurement of relative position of the body with respect to the skin 2 to accelerations of the aircraft, in particular those whose direction is perpendicular to the axis 4 of the body 1.

Advantageously, the means of measurement of a stress are distributed symmetrically about the axis 4 when the body 1 is cylindrical or in a more general way about an axis of inertia of the body 1, axis perpendicular to the surface of the skin 2. This characteristic associated with a position of the centre of gravity of the assembly at the level of the skin 2 makes it possible to obtain the same value twice, sign apart, for each means of measurement and thus to improve the sensitivity and the reliability of the incidence probe. Specifically, the measurement of a rotational movement, carried out by measurement means disposed symmetrically with respect to the point around which the rotation is performed, gives opposite results.

FIGS. 2a and 2b represent a first embodiment of the position measurement means. More precisely, the position measurement means comprise at least one strain gauge 10a fixed to the elastic means 6 and measuring a strain of the elastic means 6. FIG. 2a represents the first embodiment without the action of the air stream. The elastic means 6 are fixed on the one hand to the skin 2 and on the other hand to the body 1. The elastic means 6 for example have the form of a washer of axis 4. The strain gauge 10a is fixed to the elastic means 6 on the inside of the skin 6. The measurement of the strain of the elastic means 6 is carried out by measuring the difference in value of resistance of the strain gauge 10a between a reference position such as for example that represented in FIG. 2a and a position where the body 1 is subjected to the action of the air stream 3 as represented in FIG. 2b.

Advantageously, the position measurement means comprise several strain gauges distributed in symmetric ways around the axis 4. In FIGS. 2a and 2b two gauges have been represented and they bear the labels 10a and 10b. The variations in resistances of two strain gauges 10a and 10b disposed symmetrically are opposite. By placing these two strain gauges 10a and 10b in two opposite branches of a Wheatstone bridge supplied with a DC voltage the voltage measured at the output of the bridge is representative of the modification of position of the body 1 with a gain double that obtained with a single strain gauge 10a.

FIG. 2b represents the strain of the elastic means 6 in a direction depicted by the plane of FIG. 2b as well as the two strain gauges 10a and 10b disposed in this same plane. To obtain the actual incidence of the air stream, at least one other strain gauge, and preferably two, is (are) disposed in a plane different from that of the first two strain gauges 10a and 10b, for example perpendicular to that of FIG. 2b. The strains measured by the strain gauges disposed in orthogonal planes make it possible to reconstruct the local incidence of the air stream 3 in an orthogonal reference frame tied to the skin 2.

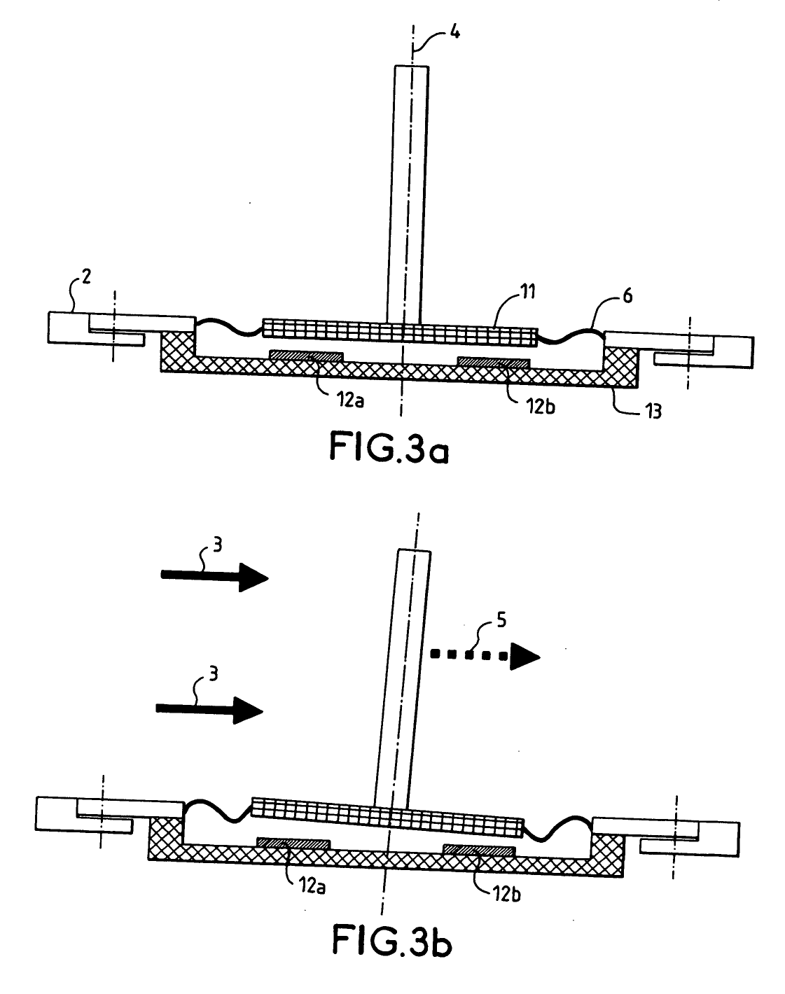

FIGS. 3a and 3b represent a second embodiment of the position measurement means. More precisely, the position measurement means comprise a first electrode 11 secured to the body 1 and at least one second electrode 12a secured to the skin 2. The two electrodes 11 and 12a form a capacitor varying as a function of the modification of the relative position of the body 1 with respect to the skin 2. FIG. 3a represents the second embodiment without the action of the air stream. The elastic means 6 are fixed on the one hand to the skin 2 and on the other hand to the body 1 for example by way of the first electrode 11. The elastic means 6 have for example as in FIGS. 2a and 2b the form of a washer of axis 4. The second electrode 12a is for example fixed inside a casing 13 fixed to the skin 2.

As in the first embodiment, the position measurement means advantageously comprise several second electrodes distributed in symmetric ways around the axis 4. In FIGS. 3a and 3b two second electrodes have been represented and they bear the labels 12a and 12b. The capacitance values between on the one hand the electrodes 11 and 12a and between on the other hand the electrodes 11 and 12b vary in an opposite way. This makes it possible, as in the first embodiment, to increase the gain in the position measurement. It is of course possible to dispose at least one other electrode secured to the skin 2, and preferably two, opposite the electrode 11, in a different plane from that of the two electrodes 12a and 12b, for example perpendicular to that of FIG. 3b so as to reconstruct the local incidence of the air stream 3 in an orthogonal reference frame tied to the skin 2.

The invention can be implemented with other position measurement means, such as for example optical means based on a Moiré effect. More precisely, the incidence probe comprises two identical transparent grids, exhibiting opaque lines. One of these grids is secured to the body 1 and the other to the skin 2. The two grids are placed opposite one another. A light ray is passed across the two grids and the intensity of the ray downstream of the two grids is analyzed. When the opaque lines of the two grids are opposite, the intensity measured downstream of the grids is maximum and when the opaque lines of the two grids are in opposition the intensity is minimum. The measurement of the intensity makes it possible to determine the relative position of the body 1 with respect to the skin 2 of the aircraft. It is possible to dispose, secured to the skin 2 at one and the same time means emitting the light ray and means of analysis of its intensity downstream of the two grids, by disposing a mirror secured to the body 1 in the optical path of the light ray.

Advantageously, the body 1 comprises reheating means so as to avoid the formation of ice on the body 1. There is a risk of ice formation occuring during flights of the aircraft at high altitude. The reheating means for example comprise a heating wire disposed inside the body 1 and supplied by a source of electrical voltage, or else means allowing the flow of a heat-carrying fluid inside the body 1.

Advantageously, the probe comprises means for determining the direction and the intensity of the stress 5 exerted by the air stream on the body 1. Specifically, the direction of the stress gives the local incidence of the air stream with respect to the probe and the intensity of the stress makes it possible to determine the speed of the air stream. More precisely, the stress is proportional to the density of the air and to the square of the speed of the air stream. The proportionality coefficient is determined by the geometry of the body 1. The density of the air may be known by means outside the probe such as for example by means of an altimeter.

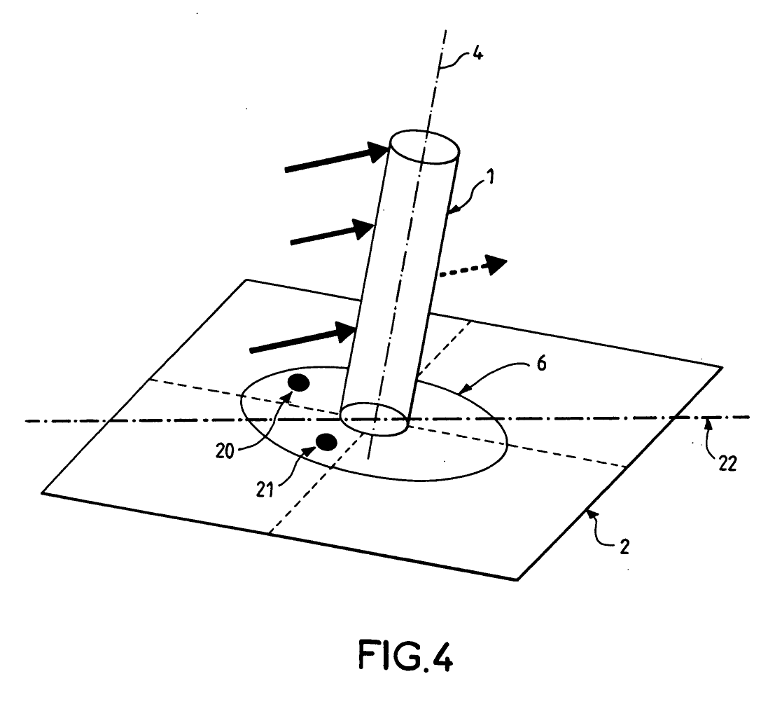

FIG. 4 represents an incidence probe advantageously comprising at least one pressure tap 20 or 21 disposed on the skin 2 in proximity to the body 1 and more precisely on the plate 6. Such a pressure tap 20 or 21 makes it possible to determine the static pressure Ps of the air stream surrounding the probe. The position of the pressure tap 20 or 21 is defined so as not to disturb the strain of the plate 6 when the body 1 is subjected to a stress 5. For this purpose, the pressure tap is in general disposed at the periphery of the plate 6.

Such a probe carrying out in one and the same item of equipment the measurements of incidence and of static pressure makes it possible to obtain, associated with another multifonction probe measuring the pressure and the total temperature, such as that described in patent application FR 2 823 846, the whole set of aerodynamic parameters of the aircraft, with the exception of the sideslip. These aerodynamic parameters are generally altered if the sideslip is not zero.

A system comprising a multifonction probe measuring the pressure and the total temperature associated with 2 probes, in accordance with the present invention, measuring the incidence and the static pressure, these latter 2 probes being situated symmetrically with respect to the plane of vertical symmetry of the airplane (right side and left side), makes it possible to calculate the sideslip and to circumvent its influence. Patent application FR 2 817 044 shows how on the basis of 2 measurements of local incidence it is possible to calculate the true incidence and true sideslip of the airplane (upstream infinite parameters), and thereafter perform all the corrections desired on the pressure measurements as a function of incidence and of sideslip.

Advantageously, the incidence probe comprises two pressure taps 20 and 21 disposed symmetrically with respect to a tangent axis 22 to the skin 2, the tangent axis 22 being concurrent with the axis 4. The incidence probe furthermore comprises means for pneumatically mixing the air bled off by the two pressure taps 20 and 21. The static pressure Ps is then determined on the basis of the pneumatic mixing. More precisely, the tangent axis 22 is demarcated on the incidence probe, for example by means of a marking. During the mounting of the incidence probe on the aircraft, the probe is oriented about its axis 4 so that the axis 22 coincides with the direction of the air stream surrounding the incidence probe when the incidence of the aircraft is zero.

In this way, if the presence of the body 1 slightly modifies the values of the pressures at the level of the two pressure taps 20 and 21, increasing the pressure on one and decreasing it on the other, the pneumatic mixing of the two pressures reduces this influence.

In any event, even if only a single pressure tap is disposed on the plate 6, it is still possible to calculate if necessary a corrected value of the static pressure Ps, on the basis of the dynamic pressure, that we know how to deduce from the measurement of the force 5 applied to the body 1.

The body 1 may be rigid, that is to say hardly strainable with respect to the means of measurement of a stress described with the aid of FIGS. 2a, 2b, 3a and 3b. By way of alternative, the body 1 can be strainable under the action of the air stream. In this case, the means of measurement of a stress 5 exerted by the air stream on the body 1 comprise means of measurement of the strain of the body 1 itself. These strain measurement means comprise for example at least one strain gauge fixed to the body 1 and measuring its flexion under the effect of the air stream. Here again it is possible to dispose on the body 1 several strain gauges around the body so as to increase the gain of the measurement and to reconstruct the local incidence.

1-14. (canceled)

15. An incidence probe for measuring incidence of an air stream flowing outside a skin, comprising:
a body situated outside the skin,
means of measurement of a stress exerted by the air stream on the body,
and a pressure tap disposed on the skin in proximity to the body.

16. The incidence probe as claimed in claim 15, wherein the means of measurement of a stress comprise elastic means maintaining the body secured to the skin, and means of measurement of relative position of the body with respect to the skin.

17. The incidence probe as claimed in claim 15, wherein the body is axisymmetric about an axis substantially perpendicular to the surface of the skin.

18. The incidence probe as claimed in claim 15, wherein it comprises a counterweight fixed to the body and disposed so that the centre of gravity of an assembly formed by the body and the counterweight is substantially situated at the level of the surface of the skin.

19. The incidence probe as claimed in claim 15, wherein the body comprises an axis of inertia perpendicular to the surface of the skin, and wherein the means of measurement of a stress are distributed symmetrically about the axis of inertia.

20. The incidence probe as claimed in claim 15, wherein the position measurement means comprise at least one strain gauge fixed to the elastic means and measuring a strain of the elastic means.

21. The incidence probe as claimed in claim 15, wherein the measurement means comprise a first electrode secured to the body and at least one second electrode secured to the skin, the two electrodes forming a capacitor varying as a function of the modification of the relative position of the body with respect to the skin.

22. The incidence probe as claimed in claim 15, wherein the body comprises reheating means.

23. The incidence probe as claimed in claim 15, comprising means for determining the direction of a stress exerted by the air stream on the body.

24. The incidence probe as claimed in claim 15, comprising means for determining the intensity of a stress exerted by the air stream on the body.

25. The incidence probe as claimed in claim 15, comprising two pressure taps disposed symmetrically with respect to a tangent axis to the skin, the tangent axis being concurrent with an axis of symmetry of the body, and wherein the incidence probe comprises means for pneumatically mixing the air bled off by the two pressure taps.
